(19) United States
(12) Patent Application Publication
(10) Pub. No.: US 2011/0068569 A1
(43) Pub. Date: Mar. 24, 2011

(54) Flexible Multi-Angle Connector For Drain Pipe And Pipe Cuff

(76) Inventor: Eric Michael Boettner, Cleveland, TN (US)

(21) Appl. No.: 12/884,131

(22) Filed: Sep. 16, 2010

Related U.S. Application Data
(60) Provisional application No. 61/243,052, filed on Sep. 16, 2009.
(60) Provisional application No. 61/286,600, filed on Dec. 15, 2009.

(51) Int. Cl. F16L 39/00; F16L 31/00

(52) U.S. Cl. 285/133.21; 285/260

(57) ABSTRACT

A coupling is provided with inner and outer diameter dimensions and structures optimized for connection with a variety of sizes and types of pipes and tubing, including the connection of three or more pipes to a coupling having at least one collapsible corrugated section.

### CLAIM OF PRIORITY

The present application claims priority to U.S. Provisional Application Ser. No. 61/243,052 filed Sep. 16, 2009 and Ser. No. 61/286,600 filed on Dec. 15, 2009.

### FIELD OF THE INVENTION

This invention relates to couplings or fittings used to combine the flows from two or more pipes.

### BACKGROUND OF THE INVENTION

When installing plumbing lines or drainage systems it is necessary to connect adjoining pipe or tubing sections by couplings. Couplings should be inexpensive, easily assembled, provide secure joinder between pipe or tubing sections and should require minimal, if any, modifications of the coupling or tube ends. Simplicity of assembly minimizes the time necessary to complete the plumbing work and therefore reduces the effective costs. In addition, a simply assembled coupling is less likely to be improperly installed and result in unwanted leakage or decoupling.

A particular issue that is encountered in plumbing and drainage systems is the need to connect two or more pipes to a single pipe. The usual couplings designed for this purpose are rigid with legs at fixed 45° or 90° angles to each other in a Y or T shape respectively, and lying in a flat plane. When using such a coupling, each of the pipes must approach the joint in a single plane and at angles matching the orientation of the legs of the coupling. This can present difficulties for the installer since the available angles are typically limited to only 90° T-couplings and 45° Y-couplings. Furthermore, if the pipes do not all lie in the same plane when using rigid couplings, then each pipe must join the main trunk line utilizing a separate connector. Rigid couplings also have legs of fixed lengths, and this requires precision in cutting and fitting the pipes or tubes to the coupling. Particularly, if there are one or more existing pipes that are to be repaired or modified, and the location of existing pipes cannot be easily moved, then precision cutting to join the pipes using rigid couplings may be a difficult and require special tools due to confined spaces.

Furthermore, it is desirable to achieve a precise fit between mating parts, typically couplings and pipes or tubing. Different sizes of pipes and tubing may be utilized in a single installation, especially when plumbing or drainage work has been installed over time, by different installers and under different standards and building codes. In the case of smaller diameter drainage systems, there are very few standards of size or tolerance and these systems are primarily installed utilizing corrugated high density plastic pipes and fittings in addition to PVC pipes and fittings. The pipes and fittings from different manufacturers have significant variations in inner and outer diameter measurements, and it is not unusual to have to join a 3″ pipe from one manufacturer made from one type of material to a 4″ pipe made by a second manufacturer from a different material. In practice, many connections are not water tight, even when using parts from a single manufacturer.

Frequently corrugated plastic pipes have a male cuff at one end that allows it to snap or fasten into the inside diameter or female cuff of a second pipe of the same type and manufacture. The manufacturers of pipes also provide fittings that fit either inside or outside of one pipe and adapt to the size of a second type or size of pipe. An example would be a reducer to adapt a 4″ corrugated pipe to a 3″ corrugated pipe. These fittings are designed for particular adaptations, so that a plumber or installer might need to carry a large number of different types of couplers to address the variety of pipes that might be encountered in repairing or adding to an existing drain system.

The enumerated issues in the prior art may be addressed by providing a coupling for three or four pipes that have at least one corrugated and collapsible leg which may be either integrally molded to the coupling or attached during use. Furthermore, the use of cuffs having a series of annular sections with different major and minor diameters and external and internal barbs may be manufactured to provide the ability to join the coupling with multiple sizes and types of pipes or tubing. Accordingly, it is one of the objects of the invention to allow an installer to adjust the length of at least one leg of a coupling in order to reach fixed ends of existing pipes.

It is another object of the invention to provide a coupler that will allow an installer to join the pipes at angles other than 90 and 45°.

It is yet a further objective of the invention to provide a coupling that will permit an installer to join a plurality of pipes that do not lie in a single plane.

It is a further object of the invention to provide couplings that are simply and securely joined, and when needed can connect to one or more sizes or types of tubing.

It is yet a further object of the invention to provide couplings that facilitate inventory management while minimizing shipping costs and warehouse and retail shelf space requirements.

It is yet another object of the invention to provide flexible couplings that minimize the stress on pipes or tubing due to misalignment.

### SUMMARY OF THE INVENTION

In accordance with one or more of these objectives, a coupling is provided with inner and outer diameter dimensions and structures optimized for connection with a variety of sizes and types of pipes and tubing, including the connection of three or more pipes to a coupling having at least one collapsible corrugated section.

### BRIEF DESCRIPTION OF THE DRAWINGS

The invention may be more fully understood with reference to the illustrative embodiments shown in greater detail in the accompanying drawings and described below by way of examples of aspects of the invention, wherein:

FIG. 1 is a plan view of a T-coupling with a central corrugated leg in collapsed form.

FIG. 2 is the T-coupling of FIG. 1 wherein the corrugated leg is in expanded form.

FIG. 3 is a plan view of a two part T-coupling with a separate corrugated leg in collapsed form.

FIG. 4 is the T-coupling FIG. 3 with the separate corrugated leg in expanded form.

FIG. 5A is a perspective view of an X-coupling having 4 corrugated legs shown in their expanded form.

FIG. 5B is a top plan view of the X-coupling of FIG. 5A.

FIG. 5C is a side plan view of the X-coupling of FIG. 5A.

FIG. 5D is an enlarged sectional view of a portion of the corrugated leg identified in FIG. 5C.

FIG. 6A is a perspective view of a Y-coupling having corrugated legs in their extended form.

FIG. 6B is a top plan view of the Y-coupling of FIG. 6A.

FIG. 6C is a side plan view of the Y-coupling of FIG. 6A.

FIG. 6D is an enlarged sectional view of the corrugated leg wall indicated in FIG. 6B.

FIG. 7 is a perspective view of an alternative Y-coupling having only one corrugated leg.

FIG. 8A is an end plan view of a coupling cuff.

FIG. 8B is a sectional side view of the coupling cuff of FIG. 8A taken along the line B-B.

FIG. 9A is an end plan view of a second coupling cuff.

FIG. 9B is a sectional side plan view of the coupling cuff of FIG. 9A taken along the line B-B.

FIG. 10 is a perspective view of a cuff having corrugated sections of different diameters and barbs.

FIG. 11 is a side plan view of the coupling of FIG. 10.

### DETAILED DESCRIPTION OF THE EXEMPLARY EMBODIMENTS

In accordance with the objectives of the invention, there are provided generally T-shaped, Y-shaped, or X-shaped couplings having at least one flexible corrugated leg. Embodiments are provided in which the flexible leg or legs may be integrally molded as a part of the coupling or attached as a separate component. Furthermore, a coupling may be provided with cuffs having major and minor diameters of different sizes and barbs to facilitate joining pipes or tubing of one or more sizes or types.

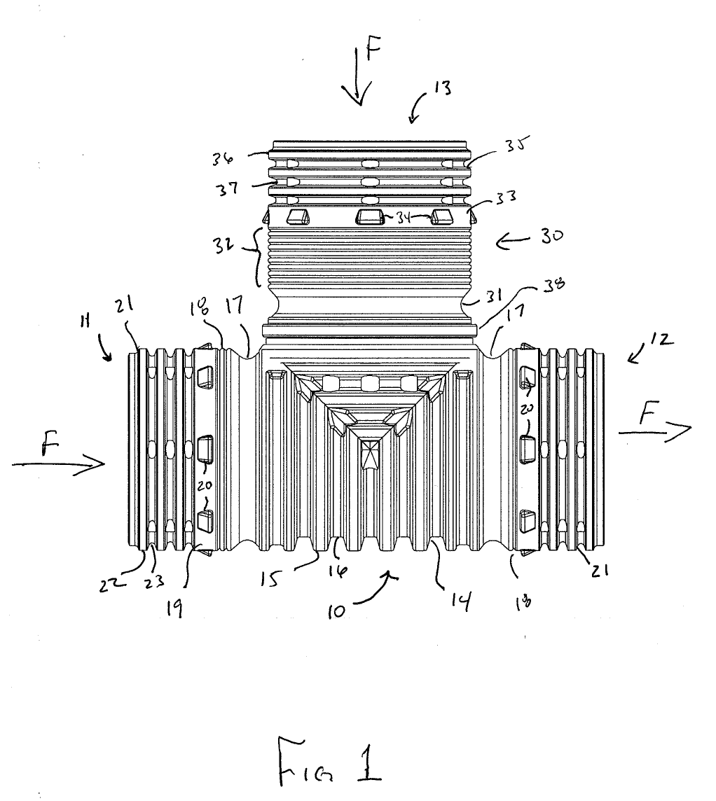

Turning first to FIG. 1, an exemplary T-coupling 10 is illustrated with first opening 11, second opening 12, and third opening 13. Arrows F indicate flow through the lumens of coupling 10. The coupling 10 is comprised of a body 14 that is depicted with reinforcing ridges 15 and valleys 16. Tooling points 17 are located on either side of the body 14. Outside the tooling points 17 are corrugated sections 18, cuff ring 19 with protruding barbs 20, and cuffs 21 having reinforcing cuff ridges 22 and cuff valleys 23, that may also serve as anchoring indentations to interlock with cuff barbs on a pipe end.

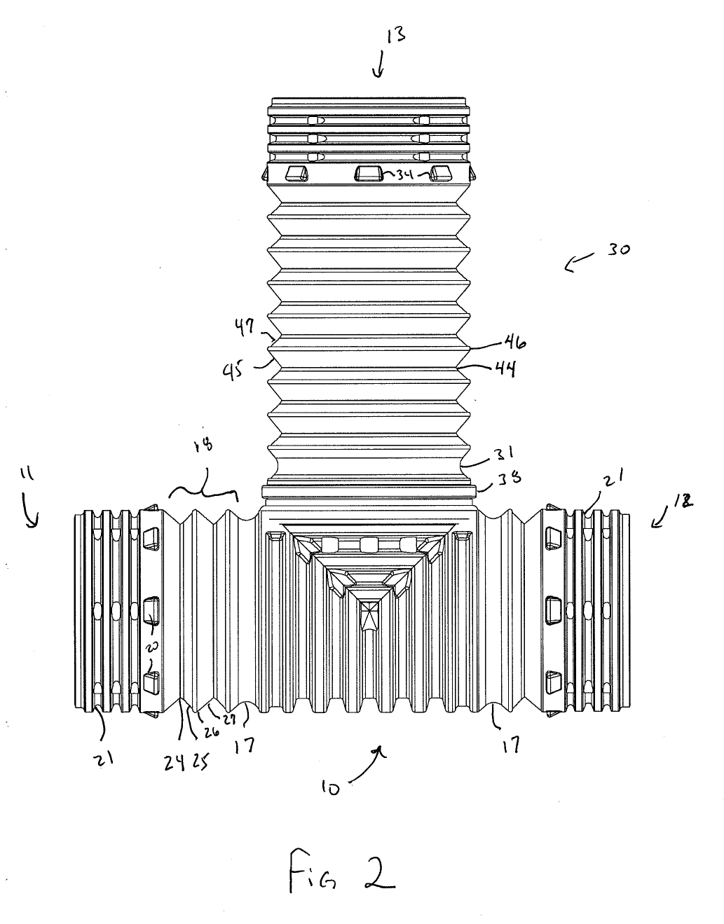

In FIG. 2, the corrugated sections 18 are opened showing the minor rings 24 connected by tuck walls 25 to major rings 26 which are in turn connected to static walls 27. The corrugated sections 18 may be collapsed in their entirety as shown in FIG. 1, or only along one edge in order to direct the associated opening 11, 12 toward a connecting pipe. Details of the construction of the corrugated sections will be understood with reference to the disclosures of commonly assigned U.S. Pat. No. 7,677,271 which is incorporated herein by reference. Turning again to FIG. 1, the leg 30 connecting the third opening 13 to the T-coupling 10 is structured similarly to the legs leading to first and second openings 11,12 but is described separately. This leg 30 has a flange 38, tooling point 31, corrugated section 32, cuff ring 33 with barbs 34, and cuff 35 with ridges 36 and valleys 37. In FIG. 2 the corrugated section 32 has been expanded to show minor rings 44 connected by static walls 45 to major rings 46 and then to tuck walls 47.

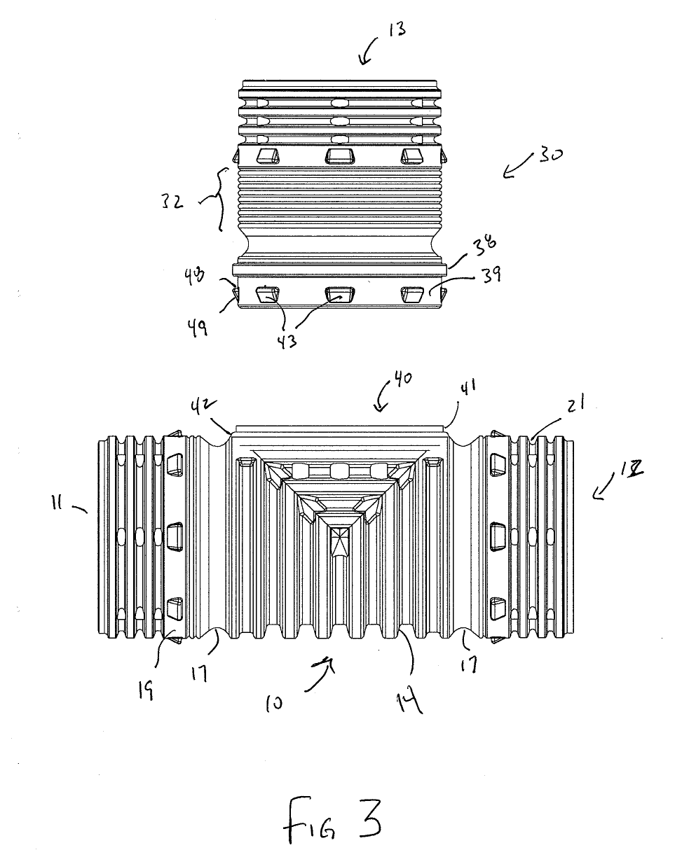

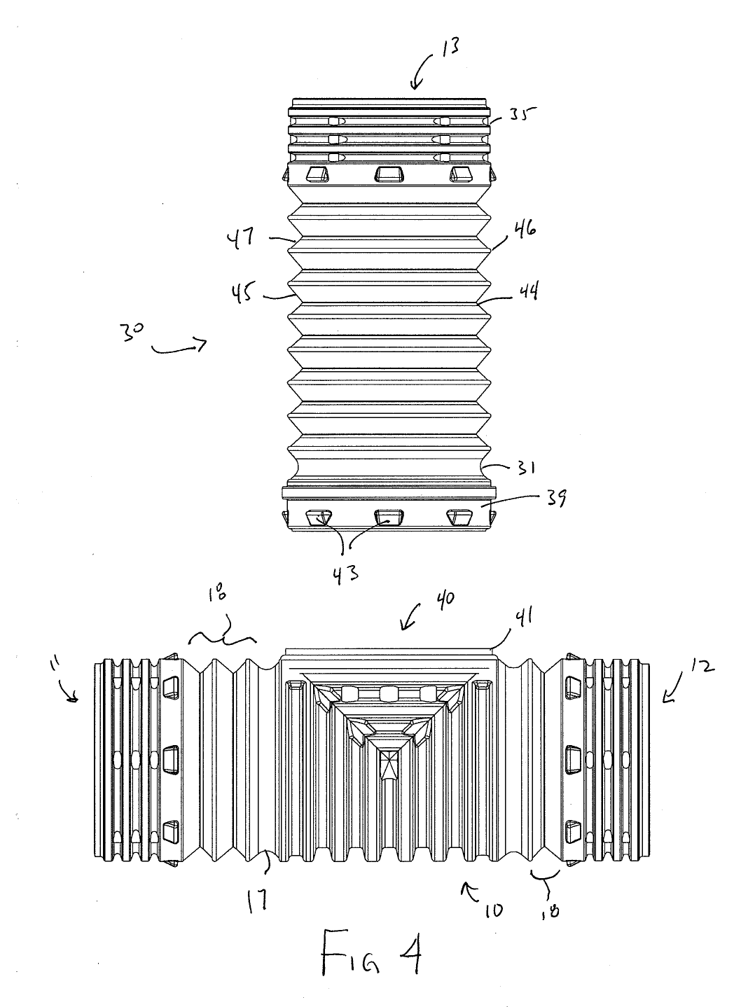

In FIG. 3, the leg 30 has been detached from body 14 of T-coupling 10. It can be seen that the opening 40 in T-coupling 10 has an edge 41 just to the interior of lip 42. When the leg cuff ring 39 is inserted within the edge 41, the sloped barb walls 49 of barbs 43 press the edge 41 outward and when flange 38 rests upon edge 41 the vertical barbed walls 48 are engaged with lip 42 to secure leg 30 to body 14. As shown in FIG. 4, leg 30 may have its corrugated section 32 expanded while separated from body 14.

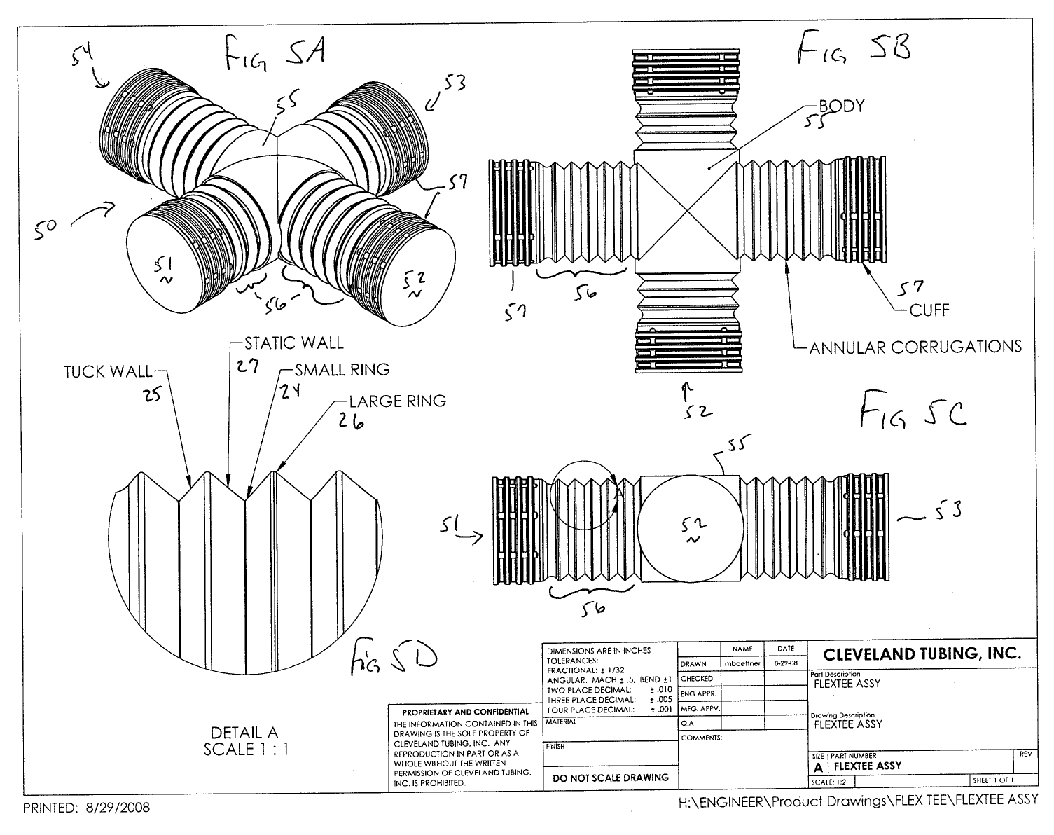

FIGS. 5A through 5D show and X-coupling 50 which might alternatively be described as a four-way T-coupling. The X-coupling 50 has a body 55 with four legs positioned at 90° angles to one another and lying in a common plane. The legs connect openings 51,52,53,54 to body 55 and are comprised of annular corrugated sections 56 and cuffs 57. The cuff section 57 of each leg may be similar to cuff 21 of FIG. 1 or may be of any similar type with locking tabs, threads or sockets. As was the case in FIG. 1, the corrugated sections 56 as shown in detail in FIG. 5D are comprised of a plurality of smaller or minor annular rings 24 connected by tuck walls 25 to larger or major annular rings 26 and then to static walls 27. It will be appreciated that corrugated sections 56 are not requires on every leg of the X-coupling 50. Suitable X-couplings 50 might only have corrugated sections 56 on one, two or three legs. Furthermore, the legs, or any of them, may be constructed as a detachable leg such as leg 30 shown in FIG. 4.

Couplings of the types described herein can be manufactured from many compositions of flexible plastic. The couplings or their components will typically be formed using either blow molding or injection molding processes. However, particularly when the components can be designed with a generally tubular shape as is the case of body 14 and leg 30 in FIG. 4, a corrugation or a continuous vacuum forming process may be used. In order to collapse or partially collapse a corrugated section, force is applied causing the tuck wall 25 to fold up into the static wall 27. The length of the leg is changed by collapsing some or all of the corrugations and the angle of the leg opening 51, 52, 53, 54 can be changed by collapsing some or all of one side of the corrugations while leaving the opposite side uncollapsed.

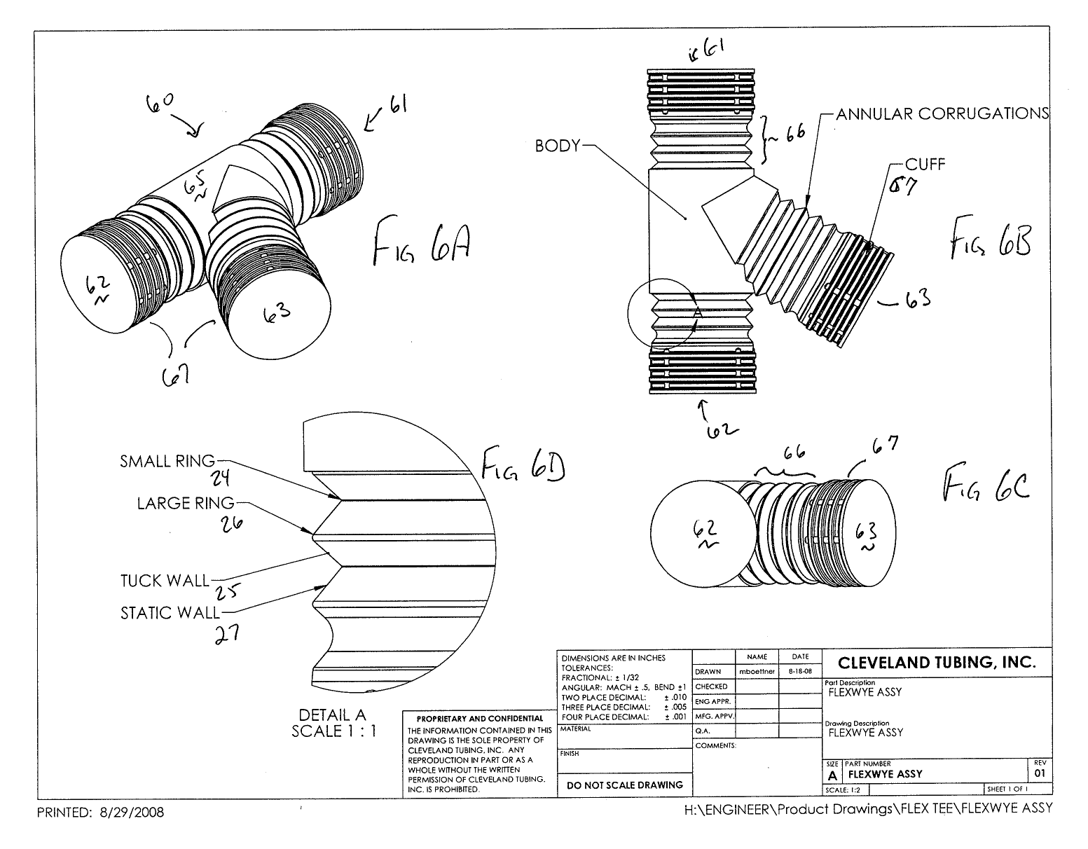

Yet another exemplary coupling is illustrated in FIGS. 6A through 6D. Coupling 60 is a Y-coupling with a body 65, connected by legs to first opening 61, second opening 62, and third opening 63. Each of the legs leading from body 65 to a respective opening comprises a corrugated section 66 and a cuff 67. If the Y-coupling 60 were of a rigid design as in the prior art, its utility would be limited. However, because the annular corrugated section connecting opening 63 to body 65 may be collapsed on one side, the coupling 60 may be converted to a T-coupling such that opening 63 is substantially normal to the channel extending between openings 61 and 62. Thus, a single flexible coupling serves the purpose of both rigid T-couplings and Y-couplings, and reduces the inventory needed for drain work. As was the case with the coupling 50 shown in FIG. 5A, corrugated sections need not be present on each leg. Furthermore, one or more legs, most particularly the leg connecting opening 63, may be removable from body 60.

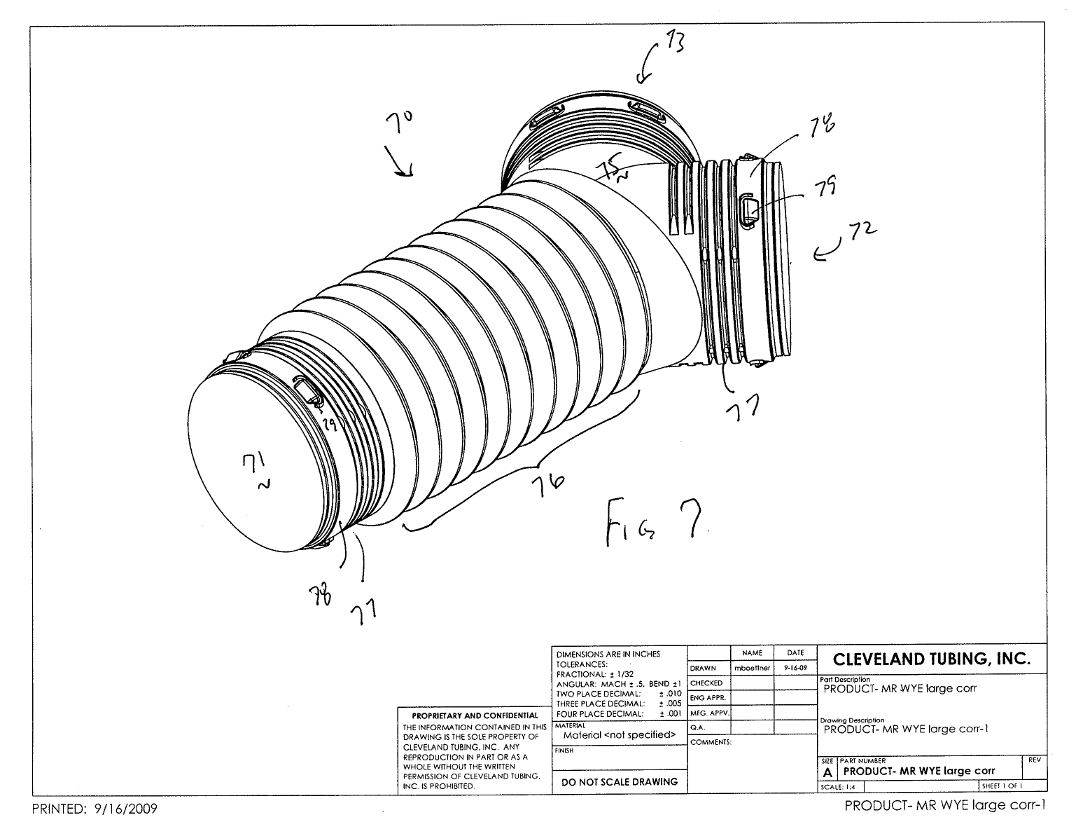

A second embodiment of a Y-coupling 70 is shown in FIG. 7. In this embodiment, a body 75 has two molded cuffs 77 defining openings 72, 73, that are fixed at approximately right angles to one another. No corrugated section extends between these cuffs 77 and the body 75. A leg with corrugated section 76 extends from body 75 to the cuff 77, cuff ring 78 with barbs 79, that defines opening 71. It will again be appreciated that the leg extending from body 75 to opening 71 could be manufactured as a detachable element such as leg 30 shown in FIG. 4.

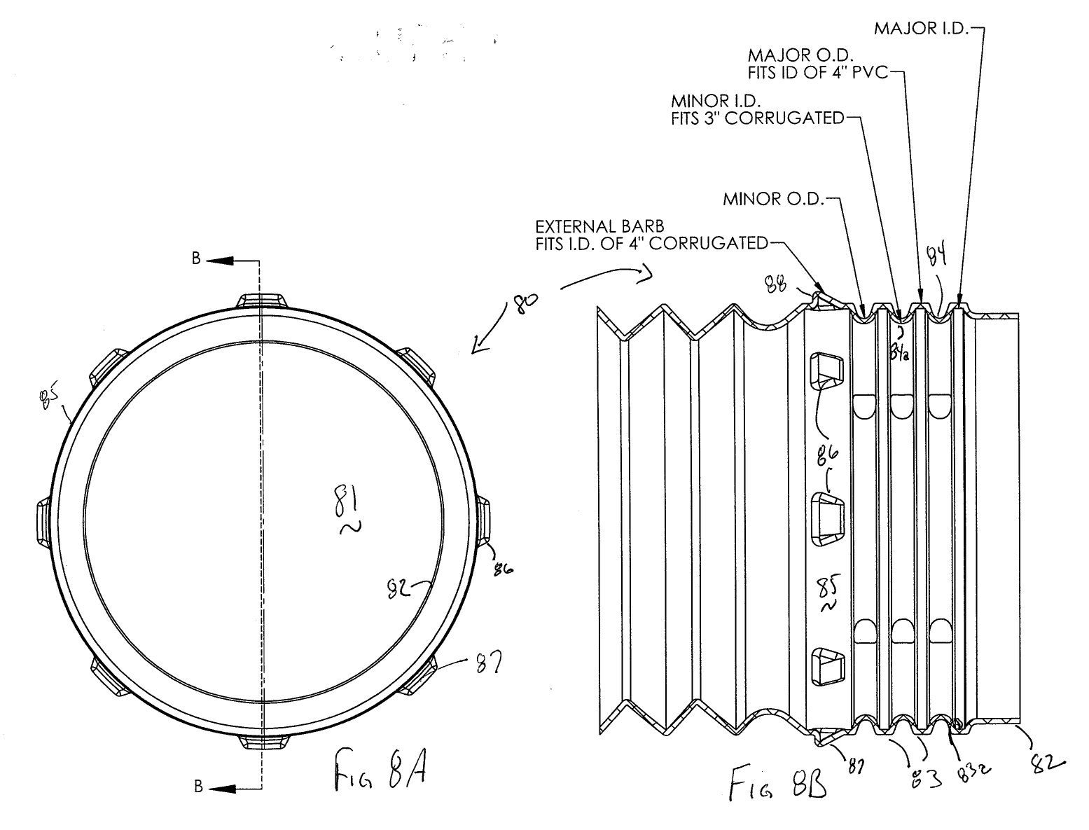

When utilizing a detachable leg, such as leg 30 shown in FIGS. 3 and 4, it is desirable not only that the leg mount securely to the coupling body, but also that the cuff 35 be designed to securely fit with the variety of pipes or tubing that might reasonably be expected in a drainage project. Cuff design to ensure a secure fit with a variety of pipes is also desirable even when a coupling is designed to join only two pipes or tubes rather than three or more. Several versitile cuff designs are illustrated in FIGS. 8 through 11.

Cuff 80 shown in FIGS. 8A and 8B has a lip 82 surrounding the lumen 81. The lip 82 connects to cuff ridges 83 and cuff valleys 84 and then to cuff ring 85 with barbs 86 having sloped forward portions 87 and nearly normal rear walls 88. The cuff ridges 83 define a major outer diameter of between approximately 3.7 and 4.3 inches that will fit inside a 4 inch PVC pipe. A major inner diameter 83a is only slightly smaller. The cuff valleys 84 define a minor outer diameter while their interior walls 84a define a minor inner diameter of between approximately 3.5 to 3.8 inches which fits on the outside, as a female cuff, of a 3 inch corrugated pipe with barbs. The external barbs 86 on cuff 80 protrude to extend to a total diameter of between 4 and 4.4 inches which will operate as a male cuff to connect with a female cuff on a 4 inch corrugated pipe.

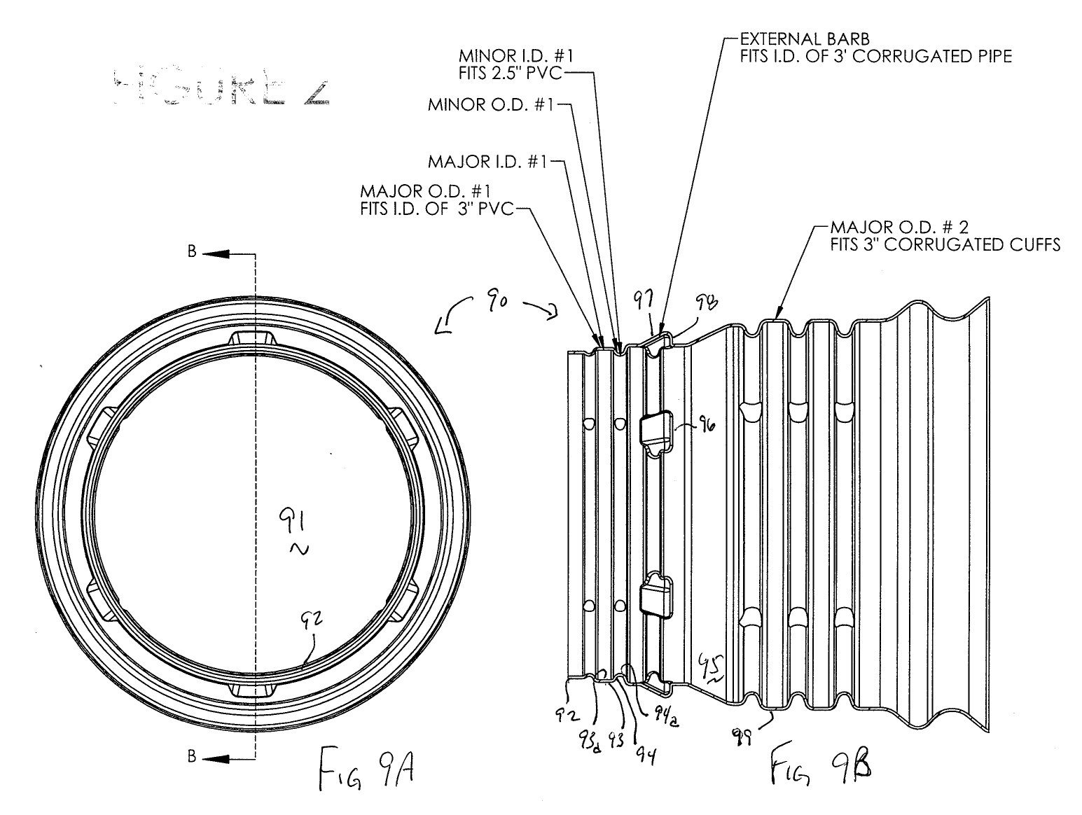

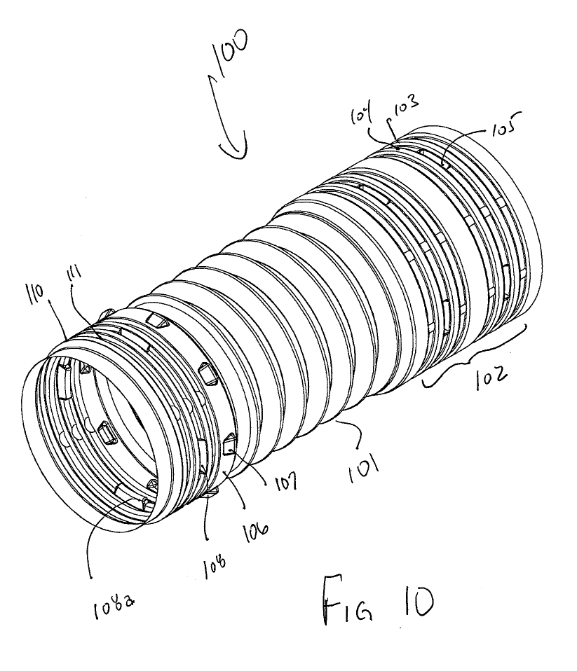

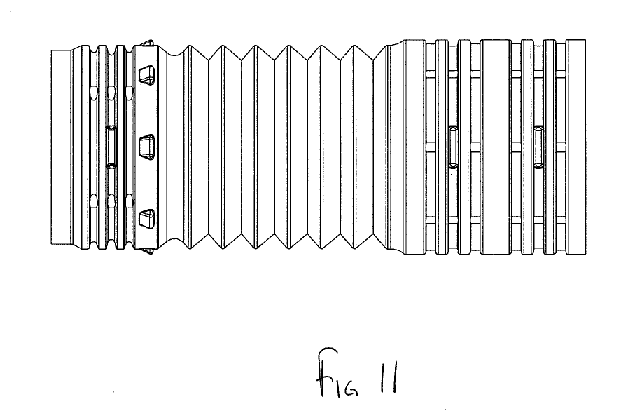

In FIGS. 9A and 9B another cuff 90 is shown with lip 92 surrounding lumen 91. The cuff proceeds to a first smaller cuff ridge 93 with inner diameter 93a and associated cuff valley 94 with inner diameter 94a and then to barbs 96 and transition 95. After the transition to a slightly larger diameter, larger cuff ridges 99 define a larger major outer diameter. This larger major outer diameter is preferably between 3.5 and 3.8 inches to join with cuffs designed to cooperate with 3 inch corrugated pipe. The first smaller cuff ridge 93 has a diameter of between about 2.9 and 3.1 inches to mate with the inner diameter of a 3 inch Schedule 40 PVC pipe. Finally, FIGS. 10 and 11 show an embodiment of a coupling leg 100 with a first cuff section having ridges 110 and valleys 111, a cuff ring 106 with protruding barbs 107 and also with internal or inwardly directed barbs 108, 108a. The second cuff section 102 of leg 100 also has cuff ridges 104 and cuff valleys 103 and inwardly pointed or internal barbs 105. Accordingly, cuffs of the disclosed design may be used to join with a variety of pipe sizes and materials, and when an especially secure or leak-free seal is desired, a silicone caulk, silicone tapes, waterproof shrink wrap seals or other suitable water resistant adhesive and filler material may be applied to the joint.

All publications, patents and patent documents are incorporated by reference herein as though individually incorporated by reference. Although preferred embodiments of the present invention have been disclosed in detail herein, it will be understood that various substitutions and modifications may be made to the disclosed embodiment described herein without departing from the scope and spirit of the present invention as recited in the appended claims.

We claim:

1. A drain pipe coupling having a hollow main body for combining the flow from at least three pipes comprising:
a first opening surrounded by a cuff and being connected to the main body;
a second opening surrounded by a cuff and being connected to the main body; and
a third opening being surrounded by a cuff and having a corrugated section connecting said cuff to the main body.

2. The drain pipe coupling of claim 1 wherein the corrugated section connecting the cuff surrounding the third opening to the main body is integrally molded with the main body.

3. The drain pipe coupling of claim 2 wherein the coupling is molded by one of the group of blow molding, injection molding, corrugation, and vacuum forming.

4. The drain pipe coupling of claim 1 wherein the corrugated section connecting the cuff surrounding the third opening to the main body is detachable from the main body.

5. A flexible plastic drain coupling having a first opening surrounded by an annular cuff with sections of varied major and minor diameters, and protruding barbs to connect said first any to any one of at least three sizes of pipe.

6. The flexible drain coupling of claim 16 further comprising a second opening surrounded by a second cuff and second cuff being adapted to interfit with an opening on a drain pipe coupling having a hollow main body for combining the flow from at least three pipes.

7. The flexible drain coupling of claim 16
